(19) United States
(12) Patent Application Publication
(10) Pub. No.: US 2008/0178009 A1
(43) Pub. Date: Jul. 24, 2008

(54) Electronic apparatus and information processing method

(75) Inventor: Takeshi Funahashi, Saitama (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 11/900,264

(22) Filed: Sep. 11, 2007

(30) Foreign Application Priority Data
Sep. 28, 2006 (JP) P2006-264022

(51) Int. Cl. H04L 9/32; H04L 9/00

(52) U.S. Cl. 713/186; 380/277

(57) ABSTRACT

An electronic apparatus connectable to an information processing apparatus includes: a reading unit configured to read biometric information; a receiving unit configured to receive a removable storage medium; and a control unit configured to perform user authentication using the biometric information read by the reading unit, and controlling, on the basis of a result of the user authentication, at least one of writing of data on the removable storage medium received by the receiving unit and reading of data stored on the removable storage medium received by the receiving unit, the data writing and the data reading being performed by the information processing apparatus connected to the electronic apparatus.

### CROSS REFERENCES TO RELATED APPLICATIONS

The present invention contains subject matter related to Japanese Patent Application JP 2006-264022 filed in the Japanese Patent Office on Sep. 28, 2006, the entire contents of which are incorporated herein by reference.

### BACKGROUND OF THE INVENTION

1. Field of the Invention

The present invention relates to electronic apparatuses and information processing methods, and, more particularly, to an electronic apparatus and an information processing method which are capable of safely storing data on a storage medium that has no encryption processing function.

2. Description of the Related Art

Currently, flash memories are becoming increasingly cheaper and are increasing in capacity. UFDs (USB Flash Disks) are therefore becoming increasingly popular as apparatuses for storing data created using a PC (Personal Computer). A user can cause a PC to recognize a UFD as an external storage medium by connecting the UFD to a USB (Universal Serial Bus) terminal of the PC, and to store data in the UFD.

Such data to be stored in a UFD is sometimes encrypted using a PC, and is then stored in the UFD. That is, only the PC can decode the encrypted data stored in the UFD. Accordingly, even if a user loses the UFD, another person cannot obtain the data stored in the UFD.

Japanese Unexamined Patent Application Publication No. 2005-504373 discloses a technique of encrypting data using a single algorithm selected from among many algorithms and storing the encrypted data in an HDD (Hard Disk Drive). Japanese Unexamined Patent Application Publication No. 2003-346122 discloses a technique of preventing leakage of personal information for authentication by storing encrypted personal information in a one-write memory instead of a flash memory. Japanese Registered Utility Model No. 3115081 discloses a technique of performing fingerprint authentication using a computer and determining whether access to a memory unit is permitted on the basis of the result of the fingerprint authentication.

### SUMMARY OF THE INVENTION

When encryption of data to be stored in a UFD is performed using a PC, data of a key used for the encryption is usually stored in an HDD included in the PC. However, even if the key data is stored in a hard-to-find part of the HDD, a malicious user can easily find it and the key data may be stolen.

Furthermore, user authentication performed prior to the encryption of such data is performed using a password input by a user, biometric information obtained by causing the user to place one of the user's fingers on a fingerprint sensor of a PC, a user ID stored in an IC card which is obtained by causing the user to hold the IC card over a reader/writer, or authentication information stored in a USB key. However, the user authentication is performed on a PC using any one of the above-described pieces of authentication information input by a user. Accordingly, information to be compared with the authentication information may be stolen from the PC.

It is desirable that data be safely stored on a storage medium that has no encryption processing function.

An electronic apparatus according to an embodiment of the present invention is connectable to an information processing apparatus and includes: a reading unit configured to read biometric information; a receiving unit configured to receive a removable storage medium; and a control unit configured to perform user authentication using the biometric information read by the reading unit, and controlling, on the basis of a result of the user authentication, at least one of writing of data on the removable storage medium received by the receiving unit and reading of data stored on the removable storage medium received by the receiving unit, the data writing and the data reading being performed by the information processing apparatus connected to the electronic apparatus.

The electronic apparatus can further include: a storage unit configured to store an encryption key and a public key corresponding to a private key stored in another electronic apparatus; and an encryption processing unit configured to encrypt data to be written which has been transmitted from the information processing apparatus connected to the electronic apparatus using the encryption key stored by the storage unit, and encrypt the encryption key using the public key stored by the storage unit. In this case, the control unit can store the data and the encryption key which have been encrypted by the encryption processing unit on the removable storage medium received by the receiving unit.

The encryption key used to encrypt data to be written which has been transmitted from the information processing apparatus connected to the electronic apparatus can be created by the electronic apparatus each time data to be written is transmitted from the information processing apparatus to the electronic apparatus.

The storage unit can also store a private key. When data encrypted using an encryption key to be stored in the other electronic apparatus and an encrypted encryption key to be stored in the other electronic apparatus which is obtained by encrypting the encryption key using a public key corresponding to the private key stored by the storage unit are stored on the removable storage medium received by the receiving unit, the encryption processing unit can decode the encrypted encryption key stored on the removable storage medium using the private key stored by the storage unit, and decode the data stored on the removable storage medium using the decoded encryption key. The control unit can transmit the data decoded by the encryption processing unit to the information processing apparatus connected to the electronic apparatus.

The electronic apparatus can further include a storage unit capable of storing data. In this case, the control unit can also control at least one of writing of data in the storage unit and reading of data stored in the storage unit, the data writing and the data reading being performed by the information processing apparatus connected to the electronic apparatus.

The electronic apparatus can further include: another storage unit configured to store an encryption key; and an encryption processing unit configured to encrypt, using the encryption key stored by the other storage unit, data to be written which has been transmitted from the information processing apparatus connected to the electronic apparatus. In this case, the control unit can store the data encrypted by the encryption processing unit in the storage unit.

The encryption processing unit can also decode the data stored by the storage unit using the encryption key stored by the other storage unit. The control unit can transmit the data decoded by the encryption processing unit to the information processing apparatus connected to the electronic apparatus.

The reading unit can read fingerprint information as the biometric information.

An information processing method according to an embodiment of the present invention is for an electronic apparatus that is connectable to an information processing apparatus and includes a reading unit configured to read biometric information and a receiving unit configured to receive a removable storage medium. The information processing method includes the steps of: performing user authentication using the biometric information read by the reading unit; and controlling, on the basis of a result of the user authentication, at least one of writing of data on the removable storage medium received by the receiving unit and reading of data stored on the removable storage medium received by the receiving unit, the data writing and the data reading being performed by the information processing apparatus connected to the electronic apparatus.

Thus, user authentication is performed on the basis of biometric information. On the basis of a result of the user authentication, at least one of the writing of data on the removable storage medium received by the receiving unit and the reading of data stored on the removable storage medium received by the receiving unit is controlled. Each of the data writing and the data reading is performed by the information processing apparatus connected to the electronic apparatus.

According to an embodiment of the present invention, data can safely be stored on a storage medium that has no encryption processing function.

### BRIEF DESCRIPTION OF THE DRAWINGS

FIG. 1 is a diagram of an exemplary external view of a UFD with a fingerprint identification function according to an embodiment of the present invention;

FIG. 2 is a block diagram illustrating an exemplary hardware configuration of the UFD with the fingerprint identification function;

FIG. 3 is a diagram illustrating exemplary pieces of data stored in an EEPROM included in the UFD illustrated in FIG. 2;

FIG. 4 is a flowchart describing a fingerprint registration process performed by the UFD with the fingerprint identification function;

FIG. 5 is a flowchart describing a fingerprint authentication process performed by the UFD with the fingerprint identification function;

FIG. 6 is a flowchart describing a process performed in step S15 illustrated in FIG. 5;

FIG. 7 is a diagram illustrating exemplary pieces of data stored in a flash memory included in the UFD with the fingerprint identification function;

FIG. 8 is a diagram illustrating exemplary pieces of data stored on a removable medium;

FIG. 9 is a flowchart describing another process performed in step S15 illustrated in FIG. 5;

FIG. 10 is a flowchart describing a series of processes performed when data is supplied from a user to another user;

FIG. 11 is a diagram illustrating exemplary pieces of data stored on a removable medium;

FIG. 12 is a diagram illustrating other exemplary pieces of data stored on the removable medium; and

FIG. 13 is a block diagram illustrating an exemplary configuration of a personal computer.

### DESCRIPTION OF THE PREFERRED EMBODIMENTS

Before describing embodiments of the present invention, the correspondence between the features of the present invention and embodiments of the present invention disclosed in this specification or the accompanying drawings is discussed below. This description is intended to assure that embodiments supporting the present invention are described in this specification or the accompanying drawings. Thus, even if an embodiment in this specification or the accompanying drawings is not described as relating to a certain feature of the present invention, that does not necessarily mean that the embodiment does not relate to that feature of the present invention. Conversely, even if an embodiment is described herein as relating to a certain feature of the present invention, that does not necessarily mean that the embodiment does not relate to other features of the present invention.

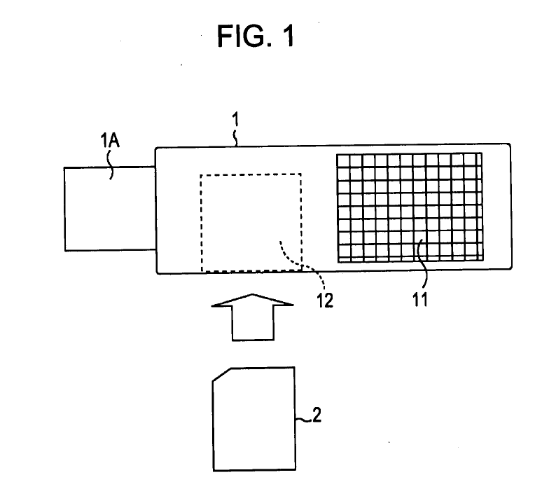

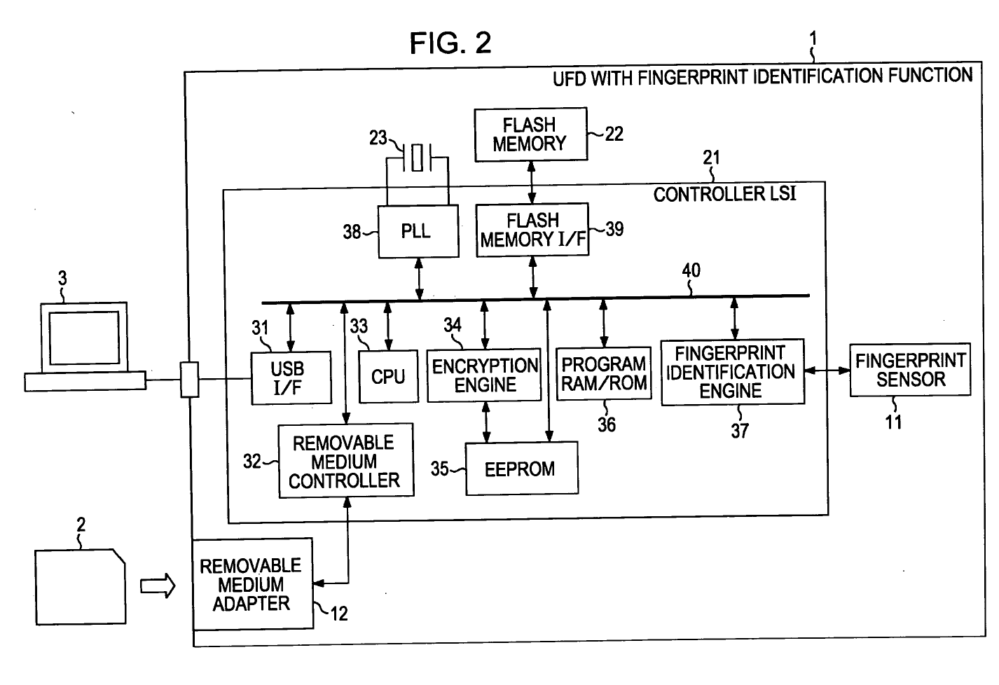

An electronic apparatus according to an embodiment of the present invention (for example, a UFD 1 with a fingerprint identification function illustrated in FIG. 1) is connectable to an information processing apparatus and includes: a reading unit (for example, a fingerprint sensor 11 illustrated in FIG. 1) configured to read biometric information; a receiving unit (for example, a removable medium adapter 12 illustrated in FIG. 1) configured to receive a removable storage medium; and a control unit (for example, a removable medium controller 32 illustrated in FIG. 2) configured to perform user authentication using the biometric information read by the reading unit, and controlling, on the basis of a result of the user authentication, at least one of writing of data on the removable storage medium received by the receiving unit and reading of data stored on the removable storage medium received by the receiving unit, the data writing and the data reading being performed by the information processing apparatus connected to the electronic apparatus.

This electronic apparatus can further include: a storage unit (for example, an EEPROM 35 illustrated in FIG. 2) configured to store an encryption key and a public key corresponding to a private key stored in another electronic apparatus; and an encryption processing unit (for example, an encryption engine 34 illustrated in FIG. 2) configured to encrypt data to be written which has been transmitted from the information processing apparatus connected to the electronic apparatus using the encryption key stored by the storage unit, and encrypt the encryption key using the public key stored by the storage unit.

This electronic apparatus can further include a storage unit capable of storing data (for example, a flash memory 22 illustrated in FIG. 2).

This electronic apparatus can further include: another storage unit (for example, the EEPROM 35 illustrated in FIG. 2) configured to store an encryption key; and an encryption processing unit (for example, the encryption engine 34 illustrated in FIG. 2) configured to encrypt, using the encryption key stored by the other storage unit, data to be written which has been transmitted from the information processing apparatus connected to the electronic apparatus.

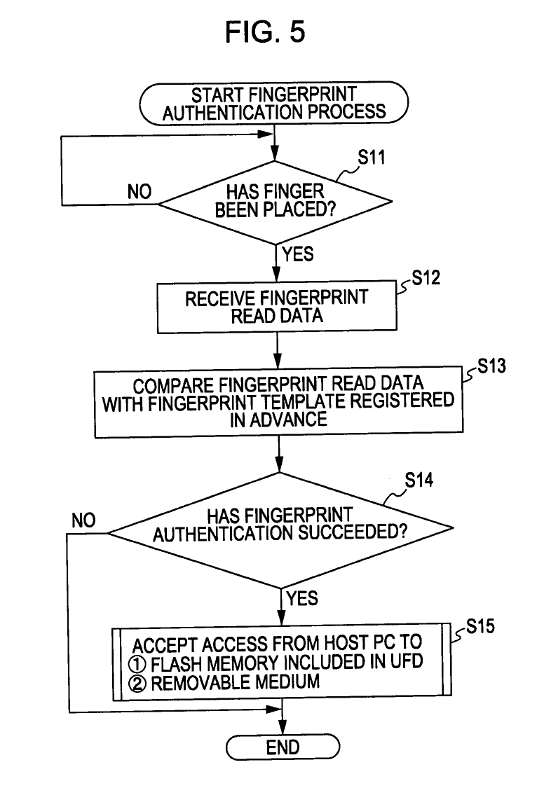

An information processing method according to an embodiment of the present invention is for an electronic apparatus that is connectable to an information processing apparatus and includes a reading unit configured to read biometric information and a receiving unit configured to receive a removable storage medium. The information processing method includes the steps of: performing user authentication using the biometric information read by the reading unit; and controlling, on the basis of a result of the user authentication, at least one of writing of data on the removable storage medium received by the receiving unit and reading of data stored on the removable storage medium received by the receiving unit, the data writing and the data reading being performed by the information processing apparatus connected to the electronic apparatus (for example, step S15 illustrated in FIG. 5).

Embodiments of the present invention will be described below with reference to the accompanying drawings.

FIG. 1 is a diagram of an exemplary external view of the UFD (USB Flash Disk) 1 with a fingerprint identification function according to an embodiment of the present invention.

The UFD 1 with the fingerprint identification function (hereinafter merely referred to as the UFD 1) has a box-shaped housing. The UFD 1 is connected to a PC by connecting a USB terminal 1A on the side of the housing of the UFD 1 to a USB terminal of the PC.

The UFD 1 contains a flash memory. A user can store various pieces of data created using a PC in the UFD 1 after connecting the UFD 1 to the PC so as to cause the PC to recognize the UFD 1 as an external storage medium.

The fingerprint sensor 11 is disposed on the surface of the housing of the UFD 1 so that the fingerprint sensor 11 is externally exposed. When a user uses the UFD 1 as an external storage medium of a PC, the user is required to connect the UFD 1 to the PC and perform fingerprint identification by placing the inner surface of one of the user's fingers on the fingerprint sensor 11. The data of the user's fingerprint read by the fingerprint sensor 11 is compared, in the UFD 1, with fingerprint data which the user registered and stored in advance in the UFD 1. When they are the same, the user can store data in the UFD 1 using the PC or read data stored in the UFD 1 using the PC.

The housing of the UFD 1 has the removable medium adapter 12 that includes a slot capable of receiving a removable medium 2 and a terminal capable of electrically connecting the UFD 1 to the removable medium 2. A user can store data on the removable medium 2 using a PC or read data stored on the removable medium 2 using the PC after inserting the removable medium 2 containing a flash memory such as a Memory Stick®, an SD® card, or a CF® into the removable medium adapter 12 of the UFD 1 connected to the PC.

That is, the UFD 1 also functions as a card reader for reading or writing data from or on the removable medium 2 inserted thereinto as well as functioning as a device with a fingerprint identification function and an external storage medium.

As will be described later, the UFD 1 stores a private key and a public key which are used to achieve PKI (Public Key Infrastructure) or an encryption key used for data encryption and data decoding. Accordingly, the UFD 1 also functions as a hardware token.

Data that has been transmitted from a PC as data to be written is always encrypted in the UFD 1, and is then stored in an internal flash memory of the UFD 1 or on the removable medium 2 inserted into the removable medium adapter 12. When a data reading command is transmitted from the PC to the UFD 1, encrypted data stored in the internal flash memory of the UFD 1 or on the removable medium 2 inserted into the removable medium adapter 12 is decoded in the UFD 1 and is then transmitted to the PC.

Even if the removable medium 2 cannot encrypt data or decode encrypted data, a user can encrypt data transmitted from a PC and store the encrypted data on the removable medium 2 or read encrypted data stored on the removable medium 2 using the PC by inserting the removable medium 2 into the removable medium adapter 12 of the UFD 1 connected to the PC.

Even if a large amount of data to be encrypted and stored cannot be stored in the internal flash memory of the UFD 1 due to insufficient memory, all of the data can be encrypted and stored by sequentially inserting a plurality of removable media 2 into the removable medium adapter 12 to split the large amount of data across the removable media 2.

Key data used to encrypt data or decode encrypted data is stored in the UFD 1. Accordingly, the risk of leakage of the key data can be reduced as compared with a case in which the key data is stored in a PC.

FIG. 2 is a block diagram illustrating an exemplary hardware configuration of the UFD 1. In FIG. 2, the same reference numerals are used for components having the same functions as those of FIG. 1.

As illustrated in FIG. 2, in the UFD 1, the fingerprint sensor 11, the removable medium adapter 12, the flash memory 22, and a crystal resonator 23 are connected to a controller LSI (Large Scale Integrated Circuit) 21.

In the controller LSI 21, a USB I/F (Interface) 31, the removable medium controller 32, a CPU (Central Processing Unit) 33, the encryption engine 34, the EEPROM (Electrically Erasable and Programmable Read-Only Memory) 35, a program RAM/ROM (Random Access Memory/Read-Only Memory) 36, a fingerprint identification engine 37, a PLL (Phase Lock Loop) 38, and a flash memory I/F 39 are connected to each other via a bus 40.

The USB I/F 31 communicates with a host PC 3 that is an external information processing apparatus connected to the UFD 1 in accordance with a USB standard. The USB I/F 31 receives data from the host PC 3 and outputs the received data to the bus 40. The data output to the bus 40 is encrypted by, for example, the encryption engine 34. The encrypted data is supplied to the flash memory I/F 39, and is then stored in the flash memory 22.

Furthermore, the USB I/F 31 receives from the encryption engine 34 via the bus 40 data that has been read out from the flash memory 22 by the flash memory I/F 39 and decoded by the encryption engine 34, and transmits the received data to the host PC 3.

The removable medium controller 32 controls writing of data on the removable medium 2 inserted into the removable medium adapter 12, or reading of data stored on the removable medium 2.

The removable medium controller 32 stores on the removable medium 2 data that has been encrypted by the encryption engine 34 and supplied from the encryption engine 34 via the bus 40. Furthermore, the removable medium controller 32 reads encrypted data stored on the removable medium 2, and outputs the read data to the encryption engine 34 via the bus 40.

The CPU 33 controls the entire operation of the UFD 1 by executing a program stored in the program RAM/ROM 36.

For example, the CPU 33 controls the access of the host PC 3 to the removable medium 2 inserted into the removable medium adapter 12 or the access of the host PC 3 to the flash memory 22. The CPU 33 permits the above-described access when receiving notification indicating that fingerprint authentication has succeeded from the fingerprint identification engine 37.

Upon receiving data to be written from the host PC 3 via the bus 40, the encryption engine 34 encrypts the received data using an encryption key stored in the EEPROM 35, and outputs the encrypted data to the removable medium controller 32 or the flash memory I/F 39 in accordance with information about a writing destination specified by the host PC 3.

Furthermore, upon receiving encrypted data that has been read from the flash memory 22 by the flash memory I/F 39 and supplied from the flash memory I/F 39, the encryption engine 34 decodes the encrypted data using the encryption key stored in the EEPROM 35, and outputs the decoded data to the USB I/F 31 so as to cause the USB I/F 31 to transmit the decoded data to the host PC 3.

Furthermore, upon receiving encrypted data that has been read from the removable medium 2 by the removable medium controller 32 and supplied from the removable medium controller 32, the encryption engine 34 decodes using a private key stored in the EEPROM 35 an encrypted encryption key to be used for decoding of the received encrypted data, decodes the received encrypted data using the decoded encryption key, and outputs the decoded data to the USB I/F 31 so as to cause the USB I/F 31 to transmit the decoded data to the host PC 3. As will be described later, an encryption key that was used for encryption of data to be written on the removable medium 2 is encrypted using a public key corresponding to the private key stored in the EEPROM 35.

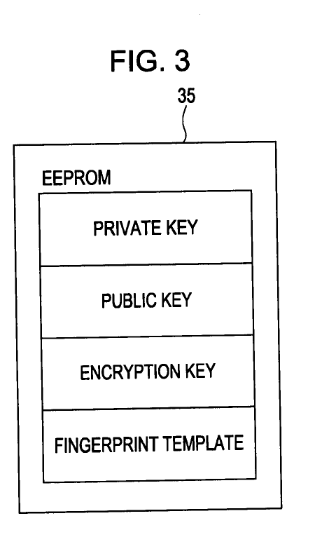

As illustrated in FIG. 3, the EEPROM 35 stores a private key, a public key, an encryption key, and a fingerprint template.

The private key, the public key, and the encryption key are read by the encryption engine 34 as appropriate, and are used for data encryption or data decoding.

The private key is used to decode data encrypted using a public key corresponding to the private key. The public key corresponding to the private key is stored in, for example, another UFD having the same configuration as that of the UFD 1.

The public key is used to encrypt an encryption key that was used for encryption of data to be stored on the removable medium 2. A private key corresponding to the public key is stored in, for example, another UFD having the same configuration as that of the UFD 1.

The encryption key includes key data compliant with RSA, AES (Advanced Encryption Standard), or DES (Data Encryption Standard), and is used to encrypt data to be stored and decode encrypted stored data.

For example, the encryption key is generated using part of fingerprint data registered by a user and data stored in the EEPROM 35 in advance. The generated encryption key is stored in the EEPROM 35. An encryption key may be generated each time data to be written is transmitted from the host PC 3 and then the generated encryption key may be stored in the EEPROM 35.

As will be described later, the private key and the public key, which are stored in the EEPROM 35, are used when a user of the UFD 1 and a user of a UFD having the same configuration as that of the UFD 1 exchange data with each other via the removable medium 2. Here, a user of the UFD 1 is defined as a user A, and a user of another UFD having the same configuration as that of the UFD 1 is defined as a user B. It is assumed that the user A and the user B exchange data with each other. In this case, a private key for the user A and a public key corresponding to a private key for the user B (public key disclosed by the user B) are stored in the EEPROM 35 included in the UFD 1 possessed by the user A. On the other hand, the private key for the user B and a public key corresponding to the private key for the user A (public key disclosed by the user A) are stored in an EEPROM included in the UFD possessed by the user B.

When the user A reads, using the host PC 3, encrypted data which the user B has stored on the removable medium 2, the private key for the user A which is stored in the EEPROM 35 included in the UFD 1 is used to decode an encryption key that has been encrypted using the public key disclosed by the user A in the UFD possessed by the user B and stored on the removable medium 2 along with the encrypted data.

When the user A encrypts and stores data to be supplied to the user B on the removable medium 2 using the host PC 3, the public key disclosed by the user B which is stored in the EEPROM 35 included in the UFD 1 is used to encrypt an encryption key to be stored on the removable medium 2 along with the encrypted data.

On the other hand, when the user B reads, using a PC of the user B, encrypted data which the user A has stored on the removable medium 2, the private key for the user B which is stored in the EEPROM included in the UFD possessed by the user B is used to decode an encryption key that has been encrypted using the public key disclosed by the user B in the UFD 1 possessed by the user A and stored on the removable medium 2 along with the encrypted data.

When the user B encrypts and stores data to be supplied to the user A on the removable medium 2 using the PC of the user B, the public key disclosed by the user A which is stored in the EEPROM included in the UFD possessed by the user B is used to encrypt an encryption key to be stored on the removable medium 2 along with the encrypted data.

The fingerprint template illustrated in FIG. 3 includes data denoting the features of a fingerprint. The fingerprint template is supplied to the fingerprint identification engine 37, and is used for fingerprint identification of a fingerprint read by the fingerprint sensor 11. The fingerprint template is obtained by the fingerprint identification engine 37 at the time of fingerprint registration and is then stored in the EEPROM 35.

Thus, various pieces of key data and the fingerprint template are stored in the EEPROM 35 included in the controller LSI 21 that includes components on a single chip. Accordingly, data leakage can be prevented as compared with a case in which the above-described pieces of data are stored in the flash memory 22 that is an external memory of the controller LSI 21.

Referring back to FIG. 2, the program RAM/ROM 36 stores various pieces of data required for the CPU 33 to perform various processing operations as well as a program to be executed by the CPU 33.

The fingerprint identification engine 37 reads a fingerprint on the basis of an RF signal supplied from the fingerprint sensor 11, and performs fingerprint identification of the read fingerprint.

For example, the fingerprint identification engine 37 determines that a finger has been placed on the fingerprint sensor 11 when the integrated value of the signal levels of RF signals output from the fingerprint sensor 11 exceeds a threshold value. A fingerprint is read in a plurality of relatively narrow areas set on the fingerprint sensor 11, whereby the above-described RF signals are output. If it is determined that a finger has been placed on the fingerprint sensor 11, the fingerprint identification engine 37 starts fingerprint reading.

The fingerprint identification engine 37 sets the fingerprint that has been read on the basis of the outputs of the fingerprint sensor 11 as a comparison target fingerprint, and compares the features of the comparison target fingerprint with the features indicated by the fingerprint template stored in the EEPROM 35. If the comparison target fingerprint has the same features as those indicated by the fingerprint template stored in the EEPROM 35, the fingerprint identification engine 37 determines that a user whose finger has been placed on the fingerprint sensor 11 is an authorized user, and notifies the CPU 33 that fingerprint authentication has succeeded.

The PLL 38 generates clocks required for units included in the controller LSI 21 to operate on the basis of clocks supplied from the crystal resonator 23, and individually supplies the generated clocks to the units.

The flash memory I/F 39 controls writing of data in the flash memory 22 that is an internal data storage memory or reading of data stored in the flash memory 22.

The flash memory I/F 39 stores in the flash memory 22 data that has been encrypted by the encryption engine 34 and supplied from the encryption engine 34 via the bus 40. Furthermore, the flash memory I/F 39 reads encrypted data stored in the flash memory 22, and outputs the read data to the encryption engine 34 via the bus 40.

In the following, the processing operations of the UFD 1 having the above-described configuration will be described. These processing operations are performed under the conditions in which the UFD 1 is connected to the host PC 3.

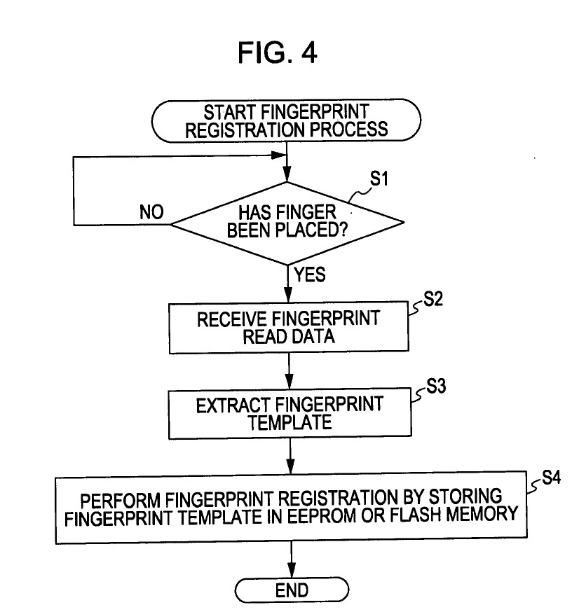

First, a fingerprint registration process performed by the UFD 1 will be described with reference to a flowchart illustrated in FIG. 4.

This fingerprint registration process is started when a user provides an instruction for registering a fingerprint by operating the host PC 3 connected to the UFD 1. When the user provides such an instruction, a fingerprint registration start command is transmitted from the host PC 3 to the UFD 1.

In step S1, the fingerprint identification engine 37 determines whether a finger has been placed on the fingerprint sensor 11. If it is determined that a finger has not yet been placed on the fingerprint sensor 11, the fingerprint identification engine 37 waits until it is determined that a finger has been placed on the fingerprint sensor 11.

For example, if an integrated value of the signal levels of RF signals that are output when an object is detected in a plurality of relatively narrow areas set on the fingerprint sensor 11 exceeds a threshold value, the fingerprint identification engine 37 determines that a finger has been placed. In this case, the process proceeds to step S2.

In step S2, when a fingerprint is read by the fingerprint sensor 11, the fingerprint identification engine 37 receives RF signals from the fingerprint sensor 11 as fingerprint read data.

In step S3, the fingerprint identification engine 37 extracts data denoting the features of the fingerprint read by the fingerprint sensor 11 from the received fingerprint read data as a fingerprint template.

In step S4, the fingerprint identification engine 37 stores the extracted fingerprint template in the EEPROM 35, thereby performing fingerprint registration. Thus, the fingerprint registration process ends.

The fingerprint template may be encrypted by the encryption engine 34 using an encryption key stored in the EEPROM 35, and then the encrypted encryption key may be stored in the flash memory 22. For example, there is no free storage area in the EEPROM 35, the fingerprint template is encrypted and is then stored in the flash memory 22 instead of the EEPROM 35.

Next, a fingerprint authentication process performed by the UFD 1 will be described with reference to a flowchart illustrated in FIG. 5.

In step S11, the fingerprint identification engine 37 determines whether a finger has been placed on the fingerprint sensor 11. If it is determined that a finger has not yet been placed on the fingerprint sensor 11, the fingerprint identification engine 37 waits until it is determined that a finger has been placed on the fingerprint sensor 11.

For example, a user places one of the user's fingers on the fingerprint sensor 11 so as to perform fingerprint authentication before data created using the host PC 3 is stored on the removable medium 2 inserted into the removable medium adapter 12 or is stored in the flash memory 22 included in the UFD 1, or when data stored on the removable medium 2 inserted into the removable medium adapter 12 or stored in the flash memory 22 included in the UFD 1 is read using the host PC 3.

If the fingerprint identification engine 37 determines in step S11 that a finger has been placed on the fingerprint sensor 11, the process proceeds to step S12. In step S12, the fingerprint identification engine 37 receives fingerprint read data from the fingerprint sensor 11.

In step S13, the fingerprint identification engine 37 sets a fingerprint indicated by the fingerprint read data as a comparison target fingerprint, and compares the features of the comparison target fingerprint with features indicated by the fingerprint template stored in the EEPROM 35.

Here, if the fingerprint template is stored in the flash memory 22, the encryption engine 34 decodes the fingerprint template stored in the flash memory 22 using the encryption key stored in the EEPROM 35. The fingerprint identification engine 37 compares the features of the comparison target fingerprint with features indicated by the decoded fingerprint template.

In step S14, the fingerprint identification engine 37 determines whether the processing of step S13 has succeeded. If the features extracted from the comparison target fingerprint are not the same as the features indicated by the fingerprint template, the fingerprint identification engine 37 determines that fingerprint authentication has failed. Here, the fingerprint authentication process ends. In this case, the access of the host PC 3 to the flash memory 22 or the removable medium 2 inserted into the removable medium adapter 12 is forbidden.

On the other hand, if the features extracted from the comparison target fingerprint are the same as the features indicated by the fingerprint template, the fingerprint identification engine 37 determines in step S14 that fingerprint authentication has succeeded and notifies the CPU 33 of the success of the fingerprint authentication.

In step S15, the CPU 33 permits the access of the host PC 3 to the flash memory 22 or the removable medium 2 inserted into the removable medium adapter 12, and performs processing for accepting access from the host PC 3.

Here, the UFD 1 performs a data writing command acceptance process of storing data supplied from the host PC 3 on the removable medium 2 or in the flash memory 22, and a data reading command acceptance process of transmitting data stored on the removable medium 2 or in the flash memory 22 to the host PC 3.

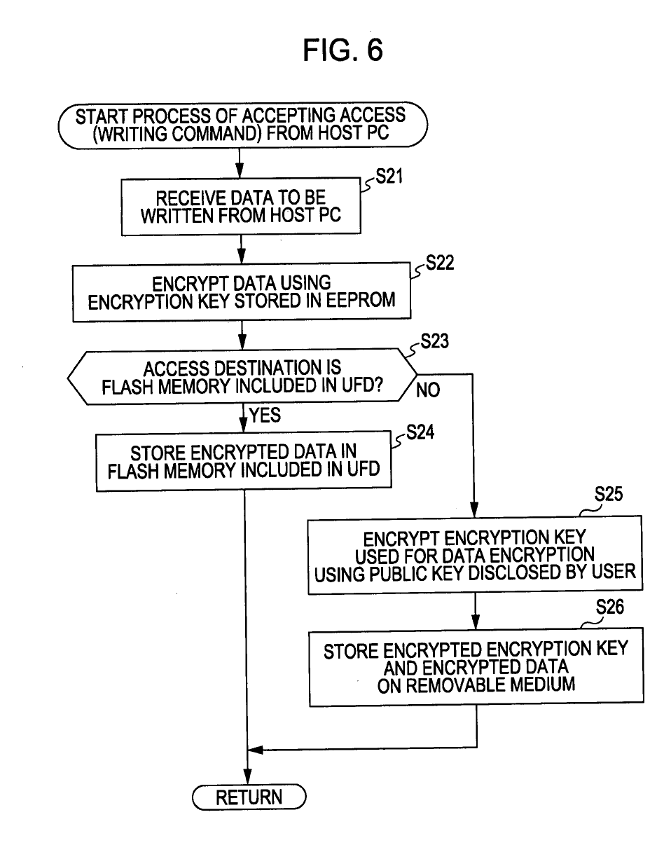

Next, the data writing command acceptance process performed by the UFD 1 in step S15 in FIG. 5 will be described with reference to a flowchart illustrated in FIG. 6.

In step S21, the encryption engine 34 receives data to be written from the host PC 3. More specifically, the data to be written that has been transmitted from the host PC 3 is received by the USB I/F 31, and is then supplied to the encryption engine 34 via the bus 40. A command including information indicating which of the removable medium 2 inserted into the removable medium adapter 12 and the flash memory 22 included in the UFD 1 should be set as a data writing destination is supplied from the host PC 3 to the CPU 33.

In step S22, the encryption engine 34 reads the encryption key from the EEPROM 35, and encrypts the data transmitted from the host PC 3 using the read encryption key.

In step S23, the CPU 33 determines whether a data writing destination (access destination) is the flash memory 22 that is an internal memory of the UFD 1 on the basis of the command transmitted from the host PC 3. If it is determined that a data writing destination is the flash memory 22, the process proceeds to step S24. In this case, the encrypted data is supplied from the encryption engine 34 to the flash memory I/F 39.

In step S24, the flash memory I/F 39 stores the data encrypted by the encryption engine 34 in the flash memory 22. Subsequently, the process returns to step S15 illustrated in FIG. 5. Thus, the data to be written that has been transmitted from the host PC 3 is encrypted and is then stored in the flash memory 22 that is an internal memory of the UFD 1.

On the other hand, if the CPU 33 determines in step S23 that a data writing destination is not the flash memory 22 that is an internal memory of the UFD 1 but the removable medium 2 inserted into the removable medium adapter 12, the process proceeds to step S25.

In step S25, the encryption engine 34 encrypts the encryption key that has been used for data encryption using a public key that is disclosed by a user of the removable medium 2 and is then stored in the EEPROM 35.

If the data writing destination is the removable medium 2, the command transmitted from the host PC 3 to the CPU 33 also includes information used to specify a user of the removable medium 2. That is, when a user stores data on the removable medium 2, the user can specify a user who will be allowed to obtain the data stored on the removable medium 2 (user who will be allowed to read the data from the removable medium 2 using a PC) as a user of the removable medium 2.

The public key disclosed by the user of the removable medium 2 is stored in the EEPROM 35 included in the UFD 1 using a predetermined method. For example, when the UFD 1 is connected to a PC used by the user of the removable medium 2, a public key is written in the EEPROM 35 included in the UFD 1 using the PC and is then stored in the EEPROM 35 along with a private key, etc. as illustrated in FIG. 3.

The user of the UFD 1 can specify a plurality of users of the removable medium 2. In this case, the encryption key used for data encryption is encrypted using each of public keys disclosed by the users who have been specified as users of the removable medium 2. The users of the removable medium 2 include the user of the UFD 1 and the friends, colleagues, and family members of the user of the UFD 1.

The encryption key encrypted using the public key disclosed by the user of the removable medium 2 and the public key used are supplied from the encryption engine 34 to the removable medium controller 32 along with the data to be written which has been encrypted in step S22.

In step S26, the removable medium controller 32 stores a pair of the encrypted encryption key and the public key that has been used for the encryption of the encryption key on the removable medium 2 inserted into the removable medium adapter 12 along with the encrypted data to be written. Subsequently, the process returns to step S15 illustrated in FIG. 5.

It is assumed that the above-described process is performed when the user A, which is a user of the UFD 1, specifies himself or herself as a user of the removable medium 2 and data transmitted from the host PC 3 is stored on the removable medium 2. In this case, data encrypted using an encryption key and a pair of a public key disclosed by the user A and an encrypted encryption key obtained by encrypting the encryption key using the public key are stored on the removable medium 2. The public key corresponds to a private key stored in the EEPROM 35 included in the UFD 1 used by the user A.

Only the host PC 3 can read the data stored on the removable medium 2 by performing a process described later when the UFD 1 into which the removable medium 2 has been inserted is connected to the host PC 3. That it, only the user A who has been specified as a user of the removable medium 2 and is a user of the host PC 3 can read the data.

It is assumed that the above-described process is performed when the user A specifies the user B as a user of the removable medium 2 and data transmitted from the host PC 3 is stored on the removable medium 2. In this case, data encrypted using an encryption key and a pair of a public key disclosed by the user B and an encrypted encryption key obtained by encrypting the encryption key using the public key are stored on the removable medium 2. The public key corresponds to a private key stored in an EEPROM included in a UFD used by the user B, and is stored on the EEPROM 35 included in the UFD 1 at a predetermined time.

Only a PC connected to the UFD used by the user B into which the removable medium 2 has been inserted can read the data stored on the removable medium 2 by performing a process described later. That it, only the user B who has been specified as a user of the removable medium 2 can read the data.

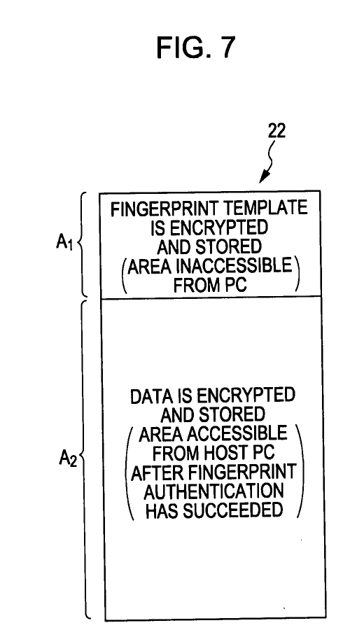

FIG. 7 is a diagram illustrating exemplary pieces of data stored in the flash memory 22.

As illustrated in FIG. 7, the storage area of the flash memory 22 includes an area A₁ and an area A₂.

The fingerprint template encrypted using the encryption key stored in the EEPROM 35 is stored in the area A₁. Even if fingerprint authentication has succeeded, information about data stored in the area A₁ is not transmitted from the UFD 1 to the host PC 3. That is, the area A₁ is inaccessible from the host PC 3.

On the other hand, the data encrypted using the encryption key stored in the EEPROM 35 is stored in the area A₂. The data writing destination in the flash memory 22 which has been described in step S24 in FIG. 6 is the area A₂. After the fingerprint authentication has succeeded, the area A₂ becomes an area accessible from the host PC 3. Accordingly, data transmitted from the host PC 3 can be stored in the area A₂, or data stored in the area A₂ can be read using the host PC 3.

Encryption of data to be stored (written) in the area A₂ and decoding of encrypted data stored in (read from) the area A₂ are automatically performed in the UFD 1 in accordance with a command transmitted from the host PC 3. Accordingly, the host PC 3 is not required to perform encryption processing at the time of data reading and data writing.

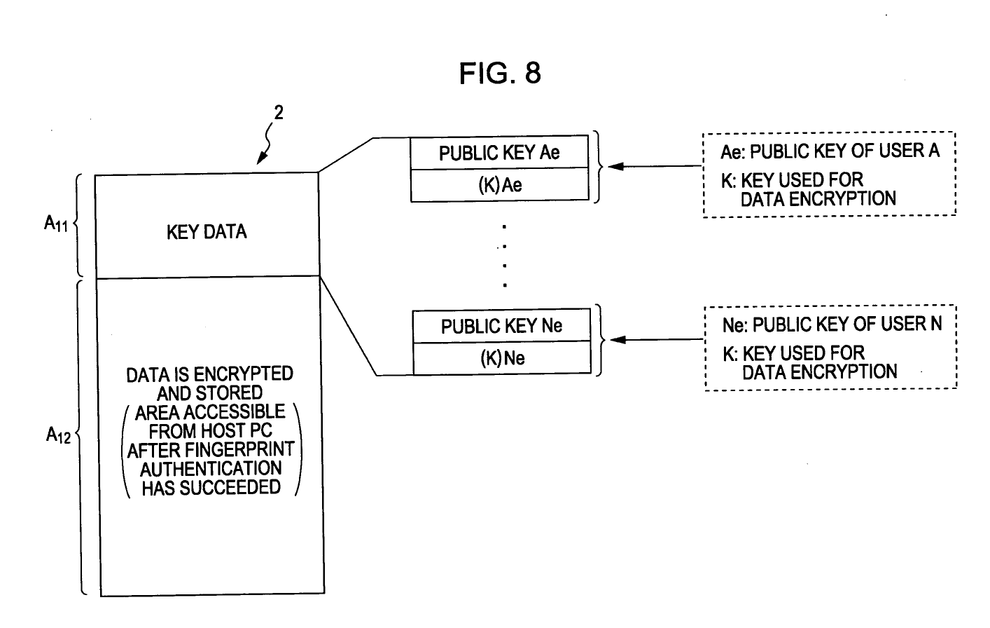

FIG. 8 is a diagram illustrating exemplary pieces of data stored on the removable medium 2 (in the flash memory included in the removable medium 2).

As illustrated in FIG. 8, the storage area of the removable medium 2 includes an area All and an area A₁₂.

A pair of a public key disclosed by each user of the removable medium 2 and an encryption key encrypted using the public key is stored in the area All. The number of pairs is the same as the number of specified users of the removable medium 2. The encryption key encrypted using the public key is a key that has been used to encrypt data to be stored in the area A₁₂. The writing destination of the pair of the public key and the encryption key which has been described in step S26 in FIG. 6 is the area All in the removable medium 2.

Referring to FIG. 8, a public key Ae denotes a public key disclosed by a user A. The public key corresponds to a private key stored in a UFD possessed by the user A. Data (K)Ae denotes an encryption key K encrypted using the public key Ae. A public key Ne denotes a public key disclosed by a user N. The public key corresponds to a private key stored in a UFD possessed by the user N. Data (K)Ne denotes the encryption key K encrypted using the public key Ne. The public key Ae and the public key Ne have already been stored in the EEPROM 35 at a predetermined time.

On the other hand, data encrypted using the encryption key stored in the EEPROM 35 is stored in the area A₁₂. The writing destination of encrypted data which has been described in step S26 in FIG. 6 is the area A₁₂ in the removable medium 2. After fingerprint authentication has succeeded, the area A₁₂ becomes an area accessible from the host PC 3. Accordingly, data transmitted from the host PC 3 can be stored in the area A₁₂, and data stored in the area A₁₂ can be read using the host PC 3.

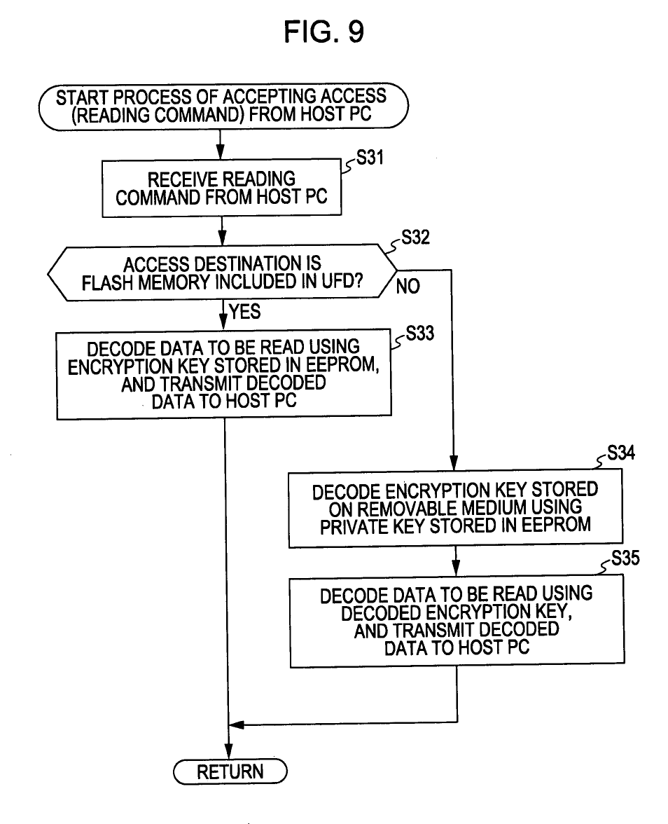

Next, the data reading command acceptance process performed in step S15 in FIG. 5 by the UFD 1 will be described with reference to a flowchart illustrated in FIG. 9.

In step S31, the CPU 33 receives a data reading command from the host PC 3. The data reading command includes information indicating which of the removable medium 2 inserted into the removable medium adapter 12 and the flash memory 22 that is an internal memory of the UFD 1 should be set as an access destination and information used to specify data to be read.

In step S32, the CPU 33 determines whether an access destination is the flash memory 22 that is an internal memory of the UFD 1 on the basis of the command transmitted from the host PC 3. If it is determined that an access destination is the flash memory 22, the process proceeds to step S33.

In step S33, the encryption engine 34 decodes, using the encryption key stored in the EEPROM 35, encrypted data that is specified by the host PC 3 as data to be read stored in the flash memory 22. The encryption engine 34 transmits the decoded data to the host PC 3 via the bus 40 and the USB I/F 31. Subsequently, the process returns to step S15 in FIG. 5. The host PC 3 performs various processing operations on the basis of the data stored in the flash memory 22.

On the other hand, if the CPU 33 determines in step S32 that an access destination is not the flash memory 22 that is an internal memory of the UFD 1 but the removable medium 2 inserted into the removable medium adapter 12, the process proceeds to step S34.

In step S34, the encryption engine 34 decodes the encryption key stored on the removable medium 2 using the private key stored in the EEPROM 35. As described previously, the removable medium 2 stores data obtained by encrypting the encryption key that has been used for data encryption using the public key corresponding to the private key stored in the EEPROM 35.

In step S35, the encryption engine 34 decodes, using the encryption key obtained in step S34, encrypted data that is specified by the host PC 3 as data to be read stored on the removable medium 2. The encryption engine 34 transmits the decoded data to the host PC 3 via the bus 40 and the USB I/F 31. Subsequently, the process ends. The host PC 3 performs various processing operations on the basis of the data stored on the removable medium 2.

It is assumed that the above-described process is performed when the user A, which is a user of the UFD 1, specifies himself or herself as a user of the removable medium 2 and data transmitted from the host PC 3 is stored on the removable medium 2. In this case, the encrypted encryption key stored on the removable medium 2 is decoded using the private key stored in the EEPROM 35 included in the UFD 1 used by the user A. Using the decoded encryption key, the data to be read is decoded.

It is assumed that the above-described process is performed when the user A specifies the user B as a user of the removable medium 2 and data transmitted from the host PC 3 is stored on the removable medium 2. In this case, the encrypted encryption key stored on the removable medium 2 is decoded using the private key stored in an EEPROM included in a UFD used by the user B. Using the decoded encryption key, the data to be read is decoded.

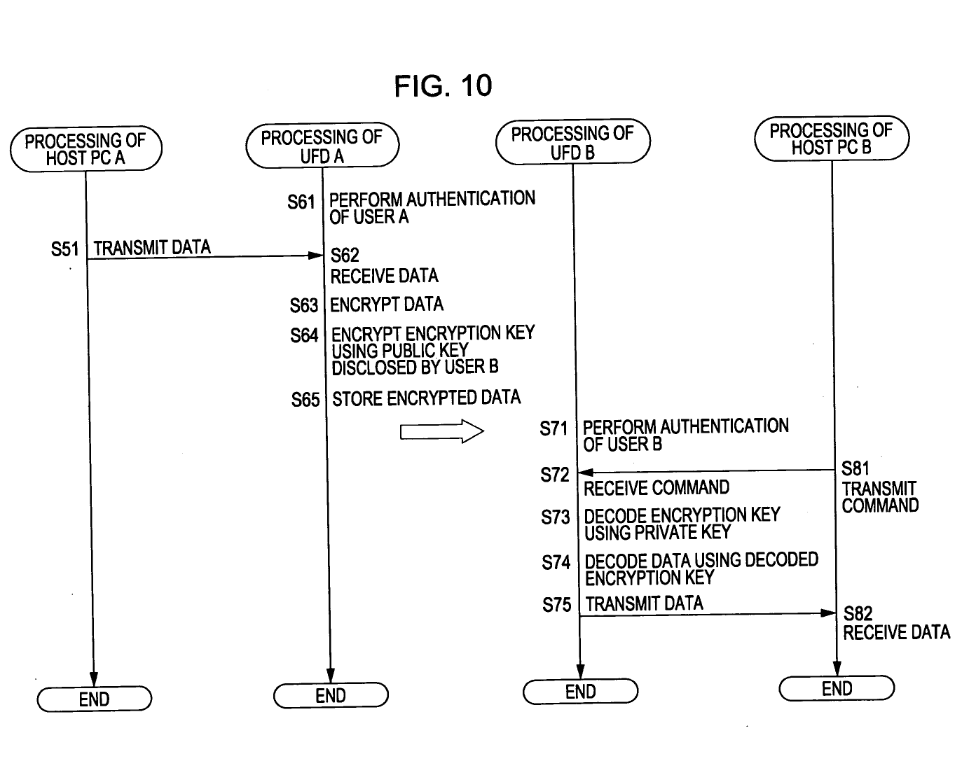

Here, a series of processes performed when the user A supplies data to the user B using the removable medium 2 will be described with reference to a flowchart illustrated in FIG. 10.

Here, the host PC 3 used by the user A is defined as a host PC A, the host PC 3 used by the user B is defined as a host PC B, the UFD 1 which the user A inserts into the USB terminal of the host PC A is defined as a UFD A, and the UFD 1 which the user B inserts into the USB terminal of the host PC B is defined as a UFD B. In the UFD A, the process described previously with reference to FIG. 6 is performed. In the UFD B, the process described previously with reference to FIG. 9 is performed.

When the user A places one of the user's fingers on the fingerprint sensor 11 of the UFD A, the UFD A performs the authentication of the user A in step S61. If the authentication has succeeded, the UFD A permits the access from the host PC A connected to the UFD A.

In step S51, the host PC A transmits data to be written to the UFD A.

In step S62, the UFD A receives the data transmitted from the host PC A. Subsequently, the process proceeds to step S63 in which the UFD A encrypts the data transmitted from the host PC A using the encryption key stored in the EEPROM 35.

In step S64, the UFD A encrypts, using the public key disclosed by the user B which is stored in the EEPROM 35, the encryption key that has been used for data encryption. Subsequently, the process proceeds to step S65 in which the UFD A stores the encrypted data and a pair of the public key disclosed by the user B and the encryption key encrypted using the public key on the removable medium 2 inserted into the removable medium adapter 12 of the UFD A.

For example, the removable medium 2 storing the encrypted data is supplied from the user A to the user B. Subsequently, the user B inserts the supplied removable medium 2 into the removable medium adapter 12 of the UFD B.

When the user B places one of the user's fingers on the fingerprint sensor 11 of the UFD B, the UFD B performs the authentication of the user B in step S71. If the authentication has succeeded, the UFD B permits the access from the host PC B connected to the UFD B.

In step S81, the host PC B transmits to the UFD B a reading command including information used to specify data to be written.

In step S72, the UFD B receives the reading command transmitted from the host PC B. Subsequently, the process proceeds to step S73 in which the UFD B decodes the encryption key stored on the removable medium 2 using the private key stored in the EEPROM 35 thereof. As described previously in step S64, this encryption key was encrypted using the public key disclosed by the user B which was stored in the UFD A used by the user A.

In step S74, the UFD B decodes the encrypted data stored on the removable medium 2 using the decoded encryption key. In step S75, the UFD B transmits the decoded data to the host PC B.

In step S82, the host PC B receives the data transmitted from the UFD B. Consequently, the data which the user A has stored on the removable medium 2 using the PC A is supplied to the host PC B used by the user B via the removable medium 2.

By performing the above-described process, the data stored on the removable medium 2 by the user A can be decoded using not only the host PC A used by the user A but also the host PC B used by the user B who has been specified by the user A.

For example, the data stored by the user A can also be decoded by the user B if the user A supplies a password set at the time of storage of the data to the user B so as to allow the user B to read the data using the same password. However, in this case, if the password is leaked, anybody may be able to decode the data. According to the above-described process, the occurrence of such a case can be prevented.

Thus, the encrypted data stored on the removable medium 2 can be decoded under a plurality of conditions such as a condition in which the fingerprint authentication of a user who stored data in an apparatus (UFD 1) has succeeded in the apparatus (UFD 1) storing the data, a condition in which the fingerprint authentication of a user who stored data in an apparatus (UFD 1) has succeeded in an apparatus that is different from the apparatus (UFD 1) storing the data but has the same configuration as that of the apparatus (UFD 1), and a condition in which the fingerprint authentication of a user specified by a user who stored data in an apparatus (UFD 1) has succeeded in an apparatus that is different from the apparatus (UFD 1) storing the data but has the same configuration as that of the apparatus (UFD 1).

Consequently, the moderately priced removable medium 2 can be used as a data storage and movement medium with a high degree of safety by inserting the removable medium 2 into the UFD 1.

Data is encrypted using an encryption key and is then stored on the removable medium 2 by a user. The encryption key used for the data encryption is encrypted. The encrypted encryption key can be decoded only by a user specified by the user. Accordingly, the encryption key can be prevented from being leaked out to third parties. Furthermore, a private key capable of decoding the encrypted encryption key is stored in the UFD 1. Accordingly, the private key can also be prevented from being leaked out. Consequently, data can be safely stored on the removable medium 2.

Furthermore, a user can cause the UFD 1 to perform authentication processing using biometric information such as fingerprint information, and to perform encryption processing only when the authentication processing has succeeded. Accordingly, a system capable of reducing the possibility that not only key data but also information about a finger template to be used for fingerprint authentication will be stolen can be constructed.

In the above-described description, a public key is used to encrypt the encryption key that has been used for data encryption. However, the encryption key may be encrypted using a common key encryption method.

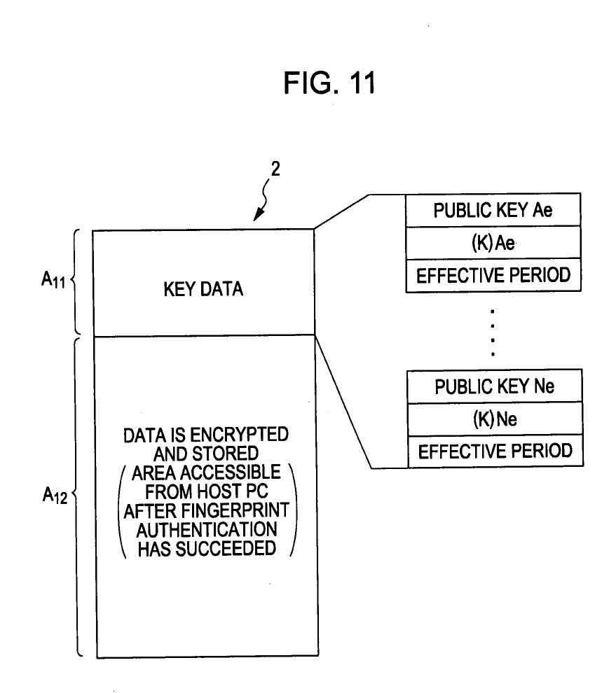

If the encryption key is encrypted using a public key, an effective period may be set for the public key and the encryption key encrypted using the public key as illustrated in FIG. 11.

In this case, for example, when the removable medium 2 is inserted into the removable medium adapter 12 of the UFD 1, it is determined whether the effective period set for the public key and the encrypted encryption key has expired. If it is determined that the effective period has already expired, the public key and the encrypted encryption key are removed from the removable medium 2.

Consequently, an effective period of stored data can be set for each specified user. That is, different effective periods can be set for stored data for which the user A has been specified as a user of the data and stored data for which the user B has been specified as a user of the data.

Furthermore, the UFD 1 may be used as a digital sign apparatus so as to identify who stored data on the removable medium 2.

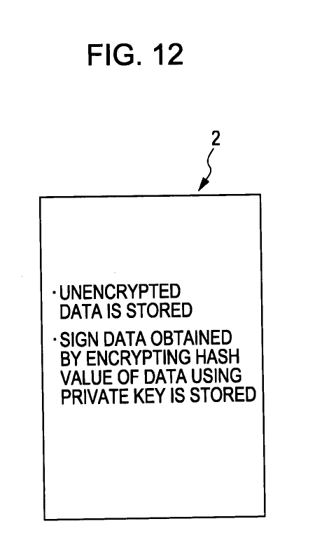

In this case, for example, as illustrated in FIG. 12, data which a user selected as data to be written is stored on the removable medium 2 inserted into the removable medium adapter 12 of the UFD 1 without being encrypted. In addition, a hash value obtained from the selected data using a hash function is encrypted using the private key stored in the EEPROM 35, whereby sign data is obtained. The obtained sign data is also stored on the removable medium 2.

When the removable medium 2 is supplied to a user, if a public key corresponding to the private key used for generation of the sign data is stored in an apparatus used by the user, the user can check the sign data using the apparatus so as to determine who wrote data on the removable medium 2.

That is, in the apparatus used by the user who obtained the removable medium 2, the sign data is decoded using the public key stored in the apparatus, whereby a hash value is obtained from the sign data. If the hash value obtained from the original data using a hash function is the same as the hash value obtained from the sign data, a user who stored data on the removable medium 2 is identified.

In this case, the apparatus used by the user who obtained the removable medium 2 is not limited to the above-described UFD, and may be another apparatus such as a PC capable of storing a public key corresponding to the private key used for generation of the sign data and receiving the removable medium 2.

Thus, by using the UFD 1 as a digital sign apparatus, it is possible to identify who wrote the data stored on the removable medium 2. This can improve the reliability of data. In addition, this can prevent a file that has been sent from an unknown sender and may contain a virus from being opened.

In the above-described description, user authentication is performed using fingerprint information obtained by the fingerprint sensor 11. However, another piece of information capable of being used for user authentication in the UFD 1 may be used instead of fingerprint information. For example, user authentication may be performed using another piece of biometric information such as iris information or palm print information unique to each individual.

In the above-described description, when fingerprint authentication has succeeded, the host PC 3 is allowed to perform both of the storage of data on the removable medium 2 or in the flash memory 2 and the reading of data stored on the removable medium 2 or in the flash memory 22. However, the host PC 3 may be allowed to perform only one of them.

In the above-described description, only one removable medium adapter (the removable medium adapter 12) is included in the UFD 1. However, a plurality of removable medium adapters may be included in the UFD 1. In this case, the removable medium adapters may be individually compliant with different standards, or may be compliant with the same standard.

In the above-described description, a Memory Stick®, an SD® card, or a CF® is used as a removable medium. However, another removable medium compliant with another standard may be used.

The series of processes described above may be performed by hardware or software. If the series of processes are performed by software, a program configuring the software is installed from a program recording medium on a computer embedded in a piece of dedicated hardware or, for example, on a general-purpose personal computer that is allowed to perform various functions by installing various programs thereon.

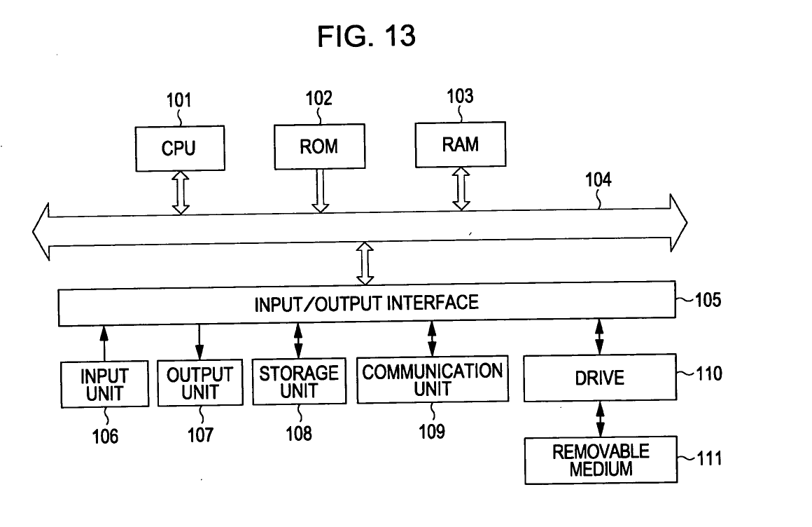

FIG. 13 is a block diagram illustrating an exemplary configuration of a personal computer that performs the series of processes described above using a program.

A CPU (Central Processing Unit) 101 performs various processing operations in accordance with a program stored in a ROM (Read-Only Memory) 102 or a storage unit 108. A RAM (Random Access Memory) 103 stores a program to be executed by the CPU 101 and data as appropriate. The CPU 101, the ROM 102, and the RAM 103 are connected to each other via a bus 104.

The CPU 101 is also connected to an input/output interface 105 via the bus 104. The input/output interface 105 is connected to an input unit 106 including a keyboard, a mouse, and a microphone, and an output unit 107 including a display and a speaker. The CPU 101 performs various processing operations in accordance with instructions input from the input unit 106, and outputs the result of processing to the output unit 107.

The storage unit 108 connected to the input/output interface 105 is configured with, for example, a hard disk, and stores a program to be executed by the CPU 101 and various pieces of data. A communication unit 109 communicates with an external apparatus via a network such as the Internet or a local area network.

When a removable medium 111 such as a magnetic disk, an optical disc, a magneto-optical disk, or a semiconductor memory is attached to a drive 110 connected to the input/output interface 105, the drive 110 drives the removable medium 111 to acquire a program or data recorded thereon. The acquired program or data is transferred to the storage unit 108 as appropriate, and is then stored in the storage unit 108.

As illustrated in FIG. 13, examples of the program recording medium storing the program to be installed on the computer and to be executed by the computer include: the removable medium 111 that is a package medium such as a magnetic disk (including a flexible disk), an optical disc (including a CD-ROM (Compact Disc-Read-Only Memory) and a DVD (Digital Versatile Disc)), a magneto-optical disk, or a semiconductor memory; the ROM 102 in which the program is temporarily or permanently stored; and the hard disk configuring the storage unit 108. The storage of the program on the program recording medium is performed via the communication unit 109 that is an interface such as a router or a modem using a wired or wireless communication medium such as a local area network, the Internet, or digital satellite broadcasting as appropriate.

In this description, the steps describing a program do not have to be executed in chronological order described above. The steps may be concurrently or individually.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus connectable to an information processing apparatus, comprising:
reading means for reading biometric information;
receiving means for receiving a removable storage medium; and
controlling means for performing user authentication using the biometric information read by the reading means, and controlling, on the basis of a result of the user authentication, at least one of writing of data on the removable storage medium received by the receiving means and reading of data stored on the removable storage medium received by the receiving means, the data writing and the data reading being performed by the information processing apparatus connected to the electronic apparatus.

2. The electronic apparatus according to claim 1, further comprising:
storing means for storing an encryption key and a public key corresponding to a private key stored in another electronic apparatus; and
encryption processing means for encrypting data to be written which has been transmitted from the information processing apparatus connected to the electronic apparatus using the encryption key stored by the storing means, and encrypting the encryption key using the public key stored by the storing means, and
wherein the controlling means stores the data and the encryption key which have been encrypted by the encryption processing means on the removable storage medium received by the receiving means.

3. The electronic apparatus according to claim 2, wherein the encryption key used to encrypt data to be written which has been transmitted from the information processing apparatus connected to the electronic apparatus is created by the electronic apparatus each time data to be written is transmitted from the information processing apparatus to the electronic apparatus.

4. The electronic apparatus according to claim 2, wherein the storing means also stores a private key, wherein, when data encrypted using an encryption key to be stored in the other electronic apparatus and an encrypted encryption key to be stored in the other electronic apparatus which is obtained by encrypting the encryption key using a public key corresponding to the private key stored by the storing means are stored on the removable storage medium received by the receiving means, the encryption processing means decodes the encrypted encryption key stored on the removable storage medium using the private key stored by the storing means, and decodes the data stored on the removable storage medium using the decoded encryption key, and
wherein the controlling means transmits the data decoded by the encryption processing means to the information processing apparatus connected to the electronic apparatus.

5. The electronic apparatus according to claim 1, further comprising storing means capable of storing data, and
wherein the controlling means also controls at least one of writing of data in the storing means and reading of data stored in the storing means, the data writing and the data reading being performed by the information processing apparatus connected to the electronic apparatus.

6. The electronic apparatus according to claim 5, further comprising:
another storing means for storing an encryption key; and
encryption processing means for encrypting, using the encryption key stored by the other storing means, data to be written which has been transmitted from the information processing apparatus connected to the electronic apparatus, and
wherein the controlling means stores the data encrypted by the encryption processing means in the storing means.

7. The electronic apparatus according to claim 6,
wherein the encryption processing means also decodes the data stored by the storing means using the encryption key stored by the other storing means, and
wherein the controlling means transmits the data decoded by the encryption processing means to the information processing apparatus connected to the electronic apparatus.

8. The electronic apparatus according to claim 1, wherein the reading means reads fingerprint information as the biometric information.

9. An information processing method for an electronic apparatus that is connectable to an information processing apparatus and includes reading means for reading biometric information and receiving means for receiving a removable storage medium, the information processing method comprising the steps of:
performing user authentication using the biometric information read by the reading means; and
controlling, on the basis of a result of the user authentication, at least one of writing of data on the removable storage medium received by the receiving means and reading of data stored on the removable storage medium received by the receiving means, the data writing and the data reading being performed by the information processing apparatus connected to the electronic apparatus.

10. An electronic apparatus connectable to an information processing apparatus, comprising:
a reading unit configured to read biometric information;
a receiving unit configured to receive a removable storage medium; and
a control unit configured to perform user authentication using the biometric information read by the reading unit, and controlling, on the basis of a result of the user authentication, at least one of writing of data on the removable storage medium received by the receiving unit and reading of data stored on the removable storage medium received by the receiving unit, the data writing and the data reading being performed by the information processing apparatus connected to the electronic apparatus.
